(19) United States
(12) Patent Application Publication
(10) Pub. No.: US 2017/0255816 A1
(43) Pub. Date: Sep. 7, 2017

(54) ELECTRONIC DEVICE AND FINGERPRINT RECOGNITION DEVICE

(71) Applicant: Lenovo (Beijing) Limited, Beijing (CN)

(72) Inventor: Ying Gao, Beijing (CN)

(73) Assignee: Lenovo (Beijing) Limited, Beijing (CN)

(21) Appl. No.: 15/445,486

(22) Filed: Feb. 28, 2017

(30) Foreign Application Priority Data
Mar. 1, 2016 (CN) 201510595948.0
Mar. 1, 2016 (CN) 201610115078.7
Mar. 1, 2016 (CN) 201610134525.3

(51) Int. Cl. G06K 9/00

(52) U.S. Cl. CPC G06K 9/00087; G06K 9/0004; G06K 9/00053

(57) ABSTRACT

One embodiment provides a detection method, comprising: detecting, using a touch pad of an electronic device, a touch operation; determining whether a touch position of the touch operation is located in a first area of the electronic device; obtaining, using an recognition apparatus of the electronic device, an image of a target associated with the touch operation responsive to determining that the touch operation is located in the first area of the electronic device. Other aspects are described and claimed.

### CLAIM FOR PRIORITY

This application claims priority to Chinese Application Nos. 201610115078.7, 201610134525.3, and 201510595948.0, filed on Mar. 1, 2106, which are fully incorporated by reference herein.

### TECHNICAL FIELD

The present invention relates to the field of electronic devices, and in particular, to an electronic device, a fingerprint recognition device, a detection apparatus, and a detection method.

### BACKGROUND

As electronic technology develops, the scope of electronic device application is getting wider and wider, and the functionality realizable by electronic devices is getting stronger and stronger. As a result, electronic devices may store huge amounts of confidential information such as a user's private information or business passwords, and meanwhile, electronic devices can realize functionalities that involve personal property and privacy such as payments and the like.

With the promotion and popularization of the mobile payment function, security of a terminal device has become an issue of great concern to users. To this end, security authentication functions are added to various terminal devices, for example, iris recognition, fingerprint recognition, face recognition, vein recognition and the like. Vein recognition has a 1% False Rejection Rate (FRR) and a False Acceptance Rate (FAR) less than 0.0001%. Thus, vein recognition is a very reliable security authentication technology.

### BRIEF SUMMARY

In summary, one aspect provides a detection method, comprising: detecting, using a touch pad of an electronic device, a touch operation; determining whether a touch position of the touch operation is located in a first area of the electronic device; obtaining, using an recognition apparatus of the electronic device, an image of a target associated with the touch operation responsive to determining that the touch operation is located in the first area of the electronic device.

Another aspect provides an electronic device, comprising: a fingerprint recognition unit comprising an acquisition module and a processing module; and wherein the acquisition module and the processing module are operatively coupled by a first connection module.

A further aspect provides a detection apparatus, comprising: a processor; a body; a touch pad disposed on the body; at least one light source located on a first area below the touch pad, wherein the first area is composed of a translucent material; and a sensor located on a second area below the touch pad.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic flow diagram illustrating an electronic device according to an embodiment.

FIG. 2 is a structural schematic diagram showing an electronic device according to an embodiment.

FIG. 3 is a structural schematic diagram showing an electronic device according to an embodiment.

FIG. 4 is a structural schematic diagram showing an electronic device according to an embodiment.

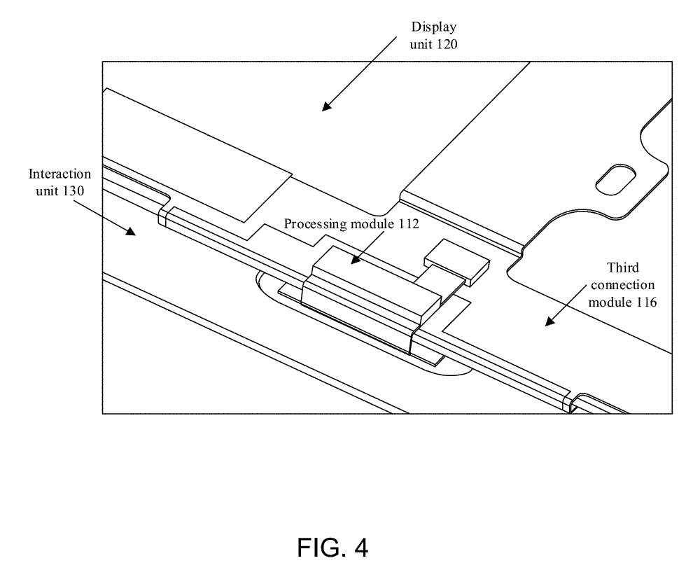

FIG. 5 is a schematic flow diagram illustrating a fingerprint acquisition device according to an embodiment.

FIG. 6 is a schematic flow diagram illustrating a detection method according to an embodiment.

FIG. 7 is a schematic flow diagram illustrating a detection method according to an embodiment.

FIG. 8 is a schematic flow diagram illustrating a detection method according to an embodiment.

FIG. 9 is a schematic flow diagram illustrating a detection method according to an embodiment.

FIG. 10 is a structural schematic diagram showing a frame for a recognition apparatus according to an embodiment.

FIG. 11 is a structural schematic diagram showing an electronic device according to an embodiment.

FIG. 12 is a structural schematic diagram showing an electronic device according to an embodiment.

FIG. 13 is a structural schematic diagram showing an electronic device according to an embodiment.

FIG. 14 is a structural schematic diagram of a detection apparatus according to an embodiment.

FIG. 15 is a structural schematic diagram of a light path detection of an embodiment according to an embodiment.

FIG. 16 is a structural schematic diagram of an electronic device according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

### Electronic Device and Fingerprint Recognition Device

Fingerprint recognition units are conventionally used to realize security authentication and the like through fingerprint verification. The fingerprint recognition unit is usually a thick integrated module that requires a lot of space for installation, otherwise it may protrude out of the electronic device. Therefore, it is obvious that such a fingerprint recognition unit is highly restricted in arrangement, or that customer satisfaction can be low.

### Embodiment I

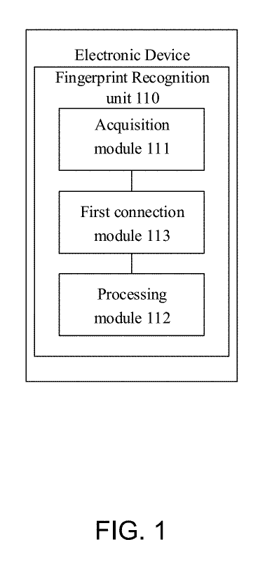

Referring now to FIG. 1, an embodiment provides an electronic device comprising a fingerprint recognition unit 110. The fingerprint recognition unit 110 comprises an acquisition module 111 and a processing module 112 that are separately arranged. The acquisition module 111 and the processing module 112 are connected through a first connection module 113 and the acquisition module 111 is used for acquiring the fingerprint information and sending the fingerprint information through the first connection module 113 to the processing module 112 for fingerprint processing. Examples of electronic devices that may be compatible with the embodiments of the underlying application include devices arranged with a fingerprint recognition unit such as a mobile phone, tablet, wearable device and the like.

The acquisition module 111 in this embodiment may comprise a fingerprint acquisition sensor. The acquisition module 111 may comprise an acquisition surface, which may be round or square shape and can detect the fingerprint information of a finger that aligns with the acquisition surface. The processing module 112 may comprise various types of information processing chips, specifically for example, a Digital Signal Processing chip DSP, Microprocessor MCU or Programmable Matrix PLC or an Application-specific Integrated Circuit.

The fingerprint recognition unit 110 in this embodiment changes the fitting arrangement between acquisition module 111 and processing module 112 in the prior art to separately arrange the acquisition module 111 from the processing module 112. In order to realize signal transmission between acquisition module 111 and processing module 112, the first connection module 113 is added which establishes a connection channel between the acquisition module 111 and the processing module 112, which can at least send the fingerprint information acquired by the acquisition module 111 to the processing module 112. The arrangement structure separating acquisition module 111 from processing module 112 reduces the volume of an individual module. In this way, when the fingerprint recognition unit 110 is arranged in an electronic device, less spare space in the electronic device can be utilized to install the fingerprint recognition unit 110. This arrangement improves the installation flexibility of the fingerprint recognition unit 110 in the electronic device without protrusion on the appearance of the electronic device, thereby improving customer satisfaction.

### Embodiment II

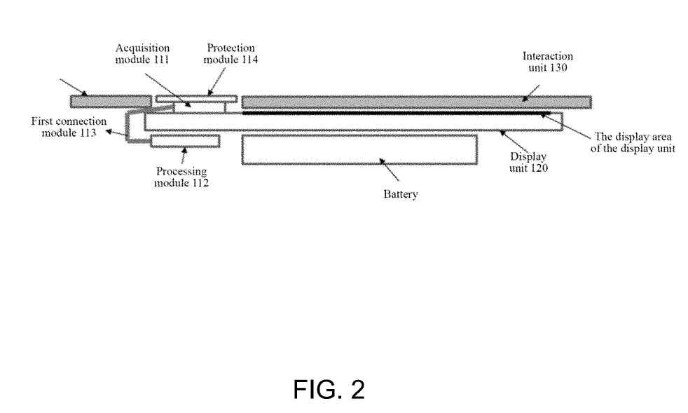

Referring now to FIG. 2, the electronic device further comprises a display unit 120. The acquisition module 111 is located on the side where the display surface of the display unit 120 is located and the processing module 112 is located on the side where the non-display surface of the display unit 120 is located. In FIG. 2, the side where the display area of the display unit is located is the display surface, wherein a user can view the information displayed in the display area on the display surface. The non-display surface is the side opposite to the display surface of the display unit 120.

In an embodiment, the acquisition module 111 and the processing module 112 are respectively located on the two sides of the display unit 120. In this way, relative to an integrated fingerprint recognition unit, there is no need to reserve an adequate space on the side where the display unit 120 is located for installation of the fingerprint recognition unit 110. Instead, the spare space on the non-display surface of the display unit 120 can be fully utilized, thereby improving flexibility of structure arrangement of the electronic device.

The display unit 120 may comprise an LCD display screen, electronic ink display screen or an organic LED (OLED) display screen. The electronic devices mentioned in this embodiment may comprise a rectangular or rectangular-like case in which an opening is provided on one side of the case, through which, the display surface of the display unit and the case together form an external surface of the electronic device. The side provided with the opening may be the side where the display surface of the electronic device is located. Generally, the display unit may also comprise a rectangular or rectangular-like display screen. The acquisition module 111 and the display unit 120 can be located on the side with the opening to facilitate detection of the user's fingerprint, also for the user to conveniently view the information displayed on the display unit 120.

### Embodiment III

In an embodiment, the display surface of the display unit 120 comprises a display area and a non-display area, as illustrated by FIG. 2. The acquisition module 111 is located in an area corresponding to the non-display area. Therefore, it is obvious that arranging the acquisition module 111 in the non-display area of the display unit 120 can prevent the acquisition module 111 from interfering with the display in the display area of the display unit 120.

### Embodiment IV

In an embodiment, the electronic device further comprises an interaction unit 130 located on the external surface of the display unit 120. The interaction unit 130 is provided with an interaction shielding area or an avoidance window in an area where the acquisition module 111 is provided. In FIG. 2, the interaction unit 130 is provided with an avoidance window in the position where the acquisition module 111 is provided.

In this embodiment, the interaction unit 110 may comprise a touch panel, and by way of a sensor, can detect the touch position of a user's finger. The touch panel may be a transparent panel. The interaction unit may also be a hovering touch panel. For example, when a user's finger is within a certain distance to the touch panel, the hovering touch panel may detect a sensor that is in close proximity to the user's finger. In short, the interaction unit 110 may be a human-machine interaction interface for interaction between a user and an electronic device.

The fingerprint recognition unit 110 in this embodiment is divided into two parts. In an embodiment, the acquisition module 111 and the display unit 120 are arranged on the same plane. In this way, the display interaction unit 130 can cover both the display unit 120 and the acquisition module 111. Additionally, because the acquisition module 111 is very thin, although the interaction unit 130 covers the acquisition module, no protrusion will be formed in the position where the fingerprint recognition unit 110 is arranged, thereby customer satisfaction will not be compromised. However, in order to avoid an interactive recognition error, in this embodiment, a shielding area for the interaction unit 130 can be provided in the area where the acquisition module 111 is arranged. In this way, the phenomenon of mistakenly recognizing a user's fingerprint acquisition operation as another operation can be avoided. Another solution provides an avoidance window for the interaction unit 130 in the position where the acquisition module 111 is arranged, wherein the avoidance window is the opening provided in the interaction unit 130. In this way, the acquisition module can go directly through the avoidance window and an external surface of the interaction unit 130. Therefore, it is obvious that no interactive recognition error will occur with this arrangement.

For the electronic device shown in FIG. 2, practice proves that with this arrangement structure of the fingerprint recognition unit 110, the spare space in the electronic device can be fully utilized so that there is no need to increase the thickness or length of the electronic device for the installation of the fingerprint recognition unit 110.

In this embodiment, to provide a shielding area for the interaction unit 130 in the position where the acquisition module 111 is arranged is the preferential option. In this way, there is no need to cut the interaction unit when making the electronic device. Therefore, the making of the electronic device can be simplified and the part of the interaction unit in the interaction shielding area can be used as the protection module for the acquisition module 111 to protect the acquisition module 111.

It shall be noted that a battery supplying power for the electronic device is also illustrated in FIG. 2.

### Embodiment V

In an embodiment, the fingerprint recognition unit 110 further comprises a protection module 114 located on the external surface of the acquisition module 111 to protect the acquisition module 111. The protection module 114 may comprise various transparent materials that are water-proof, dust-proof, oil-proof or the like, such as a glass cover piece or a plastic cover piece. The provision of the protection module in the fingerprint recognition unit 110 in this embodiment may protect and prolong the service life of the acquisition module 111.

### Embodiment VI

In an embodiment, the fingerprint recognition unit 110 further comprises a protection module 114 located on the external surface of the acquisition module 111 to protect the acquisition module 111. The protection module 114 and the acquisition module 111 are fixed together using an adhesive 114. The protection module 114 and the acquisition module 111 are fixed together using the adhesive 114, achieving simple structure and easy production. In this embodiment, it is a preferential option that the adhesive 114 is a transparent adhesive. Furthermore, in this embodiment, the transparent adhesive is a colorless transparent adhesive. In this way, the problem of low aesthetics of the electronic device and low customer satisfaction due to a color adhesive or a non-transparent adhesive can be avoided.

### Embodiment VII

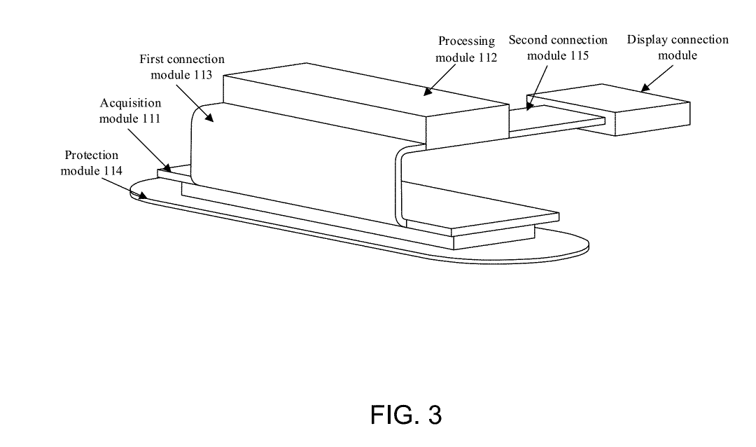

In an embodiment, the electronic device further comprises a main control unit and a display unit 120. Referring now to FIG. 3, the display unit 120 comprises a display screen and a display signal connection module 121 that are interconnected with each other. The processing module 112 is connected to the display signal connection module 121 through a second connection module 115. The display signal connection module 121 is connected to the main control unit through a third connection module 116. The third connection module 116 is used for respectively transmitting a first output signal of the display unit 120 and the second output signal of the processing module 112 to the main control unit.

The specific construction of the main control unit may comprise a processor that is capable of processing information, such as an application processor, a central processor, a microprocessor, a digital signal processor or programmable array.

In this embodiment, the electronic device may comprise a second connection module 115 and a third connection module. Both the second connection module 115 and the third connection module 116 may comprise connection lines and the like for signal transmission. In this embodiment, the processing module 112 transmits the second output signal to the display signal connection module 121, which is then transmitted by the same third connection module 116 to the main control unit. In this way, comparing to such arrangement that the processing module 112 is connected to the connection module of the main control unit alone, the additional connection module is reduced.

In specific implementation, lines for transmitting the output signals of the transmitting module 122 that transmits a display signal and the processing module 112 can be respectively provided on the third connection module 116. A time division multiplexing method can be adopted to adopt an integrated line to transmit the first output signal and the second output signal.

In short, the construction design of the electronic device described in this embodiment has the characteristics of a delicate structure, with fewer components and a flexible arrangement.

### Embodiment VIII

The first connection module comprises a flexible connection circuit board. The flexible connection circuit board mentioned in this embodiment is a Flexible Printed Circuit (FPC). The FPC may also be known as a flexible circuit board, flexible printed circuit board, flexible board, and is high in density, light weight and thin. The electronic device in this embodiment adopts the FPC and is also light weight and thin. In addition, the FPC is usually plug-and-play, allowing for easy assembly and production of the electronic device, which is due to the protecting layer on the surface of the FPC, and it is also durable and has a long service life. In an embodiment, the second connection module and the third connection module described in the previous embodiment can also comprise the FPC.

### Embodiment IX

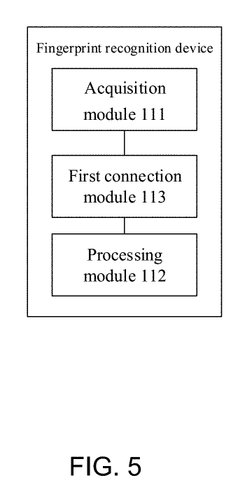

Referring now to FIG. 5, a fingerprint recognition device according to an embodiment is illustrated. In an embodiment, the fingerprint recognition device comprises: an acquisition module 111 for acquiring fingerprint information; a processing module 112, arranged separately from the acquisition module for processing the fingerprint information; and a first connection module 113, having one end electrically connected to the acquisition module, and the other end electrically connected to the processing module, and transmitting the fingerprint information to the processing module.

The acquisition module 111 described in this embodiment can comprise various types of sensors that acquire fingerprints by scanning the fingerprint or by detecting the pressure applied by the user's finger. The processing module can comprise various types of processing chips, such as a Microprocessor chip MCU, Digital Signal Processing chip DSP, or Programmable Matrix PLC.

In this embodiment, the acquisition module 111 and the processing module 112 are arranged separately without forming an integrated acquisition processing device. The acquisition module 111 and the processing module 112 are connected through the first connection module 113 and the first connection module can be the FPC described in the previous embodiment. The fingerprint acquisition device described in this embodiment has high installation flexibility and fewer device construction changes after installation.

### Detection Method and Electronic Device

In vein recognition technology, the infrared radiation light source irradiates infrared radiation light onto a finger, and a vein sensor acquires infrared radiation imaging on the finger and further obtains vein data. Integrating the vein sensor and the light source onto a notebook computer allows realization of a finger vein recognition function on the notebook computer. For this purpose, the vein sensor and the light source are integrated on a touch pad of the notebook computer.

Based on this, a finger vein recognition module is required to operate in a standby state when the finger vein recognition function is utilized to realize intelligent startup or when the finger vein recognition function is utilized to realize system-related controls. During standby, a user may use the finger vein recognition function at any time, so as to require that the finger vein recognition module, when on standby, may respond to user's requirement in time. However, when an existing finger vein recognition module is on standby, the vein sensor and the light source are required to judge whether the finger vein recognition function is being used, and the vein sensor and the light source are required to be scanned constantly, thereby resulting in a very high standby power consumption.

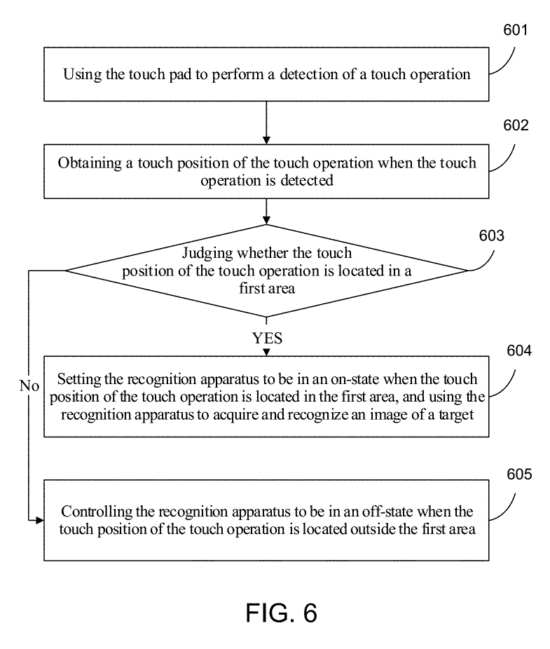

Referring now to FIG. 6, a schematic flow diagram of a detection method according to an embodiment is illustrated. A detection method in this example is applied to an electronic device which comprises a body, a touch pad disposed on the body, and a recognition apparatus located below the touch pad.

At Step 601, the touch pad is used to perform a detection of a touch operation. In an embodiment, the electronic device may be a device such as a notebook computer, a tablet computer, and the like. The electronic device comprises a body, a touch pad disposed on the body, and a recognition apparatus located below the touch pad. The recognition apparatus comprises a sensor and more than one light source.

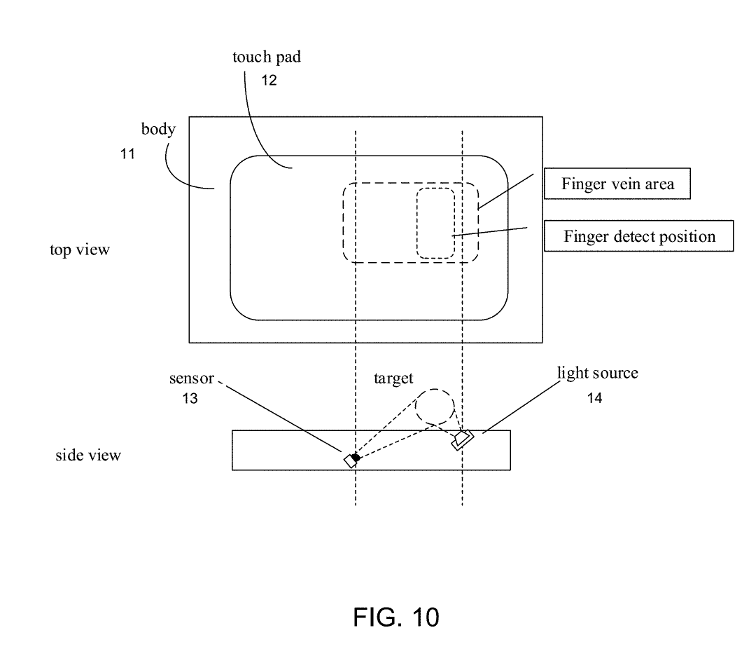

Taking the case where the recognition apparatus comprises one light source as an example, with reference to FIG. 10, one light source is located in a first area below the touch pad, the sensor is located in a second area below the touch pad, and the first area is different from the second area. In the embodiment, the body refers to a casing carrying the touch pad, the shape of the body can be a rectangle, or a rectangle with rounded corners, and the like, and the shape of the body can be designed flexibly according to user's requirements and preferences. A light material such as plastic and the like is generally employed as the material of the body to reduce weight of the electronic device.

In an embodiment, the touch pad is disposed on the body, and the touch pad provides a touch operation function for the user. That is, the user can realize a touch operation on the touch pad, wherein the touch pad, after acquiring the touch operation of the user, sends a generated control instruction to the processor for response by the processor. In one implementation, the operating principle of the touch pad is as follows: when the user's finger approaches or touches the touch pad, capacitance will be changed and an amount of change in capacitance will be detected by a control integrated circuit (IC) of the touch pad, and converted into a control instruction related to a coordinate. The touch pad learns a finger movement condition by means of capacitive sensing and when the finger touches the pad surface, an electrostatic field above the pad surface will be changed. In addition, the touch pad may further have other types of operating principles, and the realized functions are the functions for providing the touch operation for the user.

In an embodiment, the sensor and one light source are integratedly designed below the touch pad and the sensor and the light source are capable of realizing acquisition of the finger vein image. One light source is provided at the second area below the touch pad. Specifically, with reference to FIG. 10, a light source is provided at a second position of the second area below the touch pad. The function of the light source is to radiate the light through the touch pad onto the target. The target here refers to an object having vital signs, such as fingers having blood flowing. When the light is radiated through the touch pad onto the target, flowing blood in the target has different biological manifestations as a result of the radiation.

In an embodiment, a sensor is provided at the first area below the touch pad. Specifically, with reference to FIG. 10, a sensor is provided at a first position of the first area below the touch pad and the function of the sensor is to acquire the finger vein image. In particular, the flowing blood in the target has different biological manifestations as a result of the radiation and based on this, the sensor detects the image of the target formed as a result of the radiation of light. Here, the target particularly refers to the finger, such that the detected image is the finger vein image.

In an embodiment, when the light source is located in the first area below the touch pad, light emitted from the light source is capable of being radiated through the touch pad onto the first side of the target. When the sensor is located in the second area below the touch pad, the sensor is capable of detecting an image of the second side of the target formed as a result of the radiation of light. An area of the first side is different from an area of the second side. With reference to FIG. 10, the light emitted from the light source is capable of being radiated through the touch pad onto the right side of the target and the sensor is capable of detecting the image of the left side of the target formed as a result of the radiation of light.

In an embodiment, the position of the target is referred to as a finger detect position, and an area on the touch pad in which the image of the target is capable of being detected is referred to as a finger vein area.

In an embodiment, the touch pad employs a design of the sensor on glass, and the sensor here refers to the sensor for realizing the function of the touch pad. A bottom surface of the touch pad is coated with a light-shielding layer which is capable of projecting a first wave band light and reflecting a second wave band light. In an embodiment, the light emitted from the light source belongs to the first wave band and the light reflected from surfaces of the light source and the sensor belongs to the second wave band. In particular, a bottom surface of glass is coated with black ink as a light-shielding layer. The black ink is only transparent to infrared radiation (IR) light and reflects other wave band light, thereby ensuring that the sensor and the light source devices inside the touch pad would be hidden from view and that the appearance is aesthetic. Here, the black ink is capable of projecting light at 850 nm, and light transmittance is 90%.

In an embodiment, the sensor comprises a lens and a photosensitive layer and the light reflected from the target as a result of the radiation of light is capable of being converged on the photosensitive layer through the lens to form an image. Here, the focus of the lens is adjusted to a suitable range according to the position of the sensor, and the light reflected from the target as a result of the radiation of light is capable of being converged on the photosensitive layer through the lens to form an image. In one implementation, the photosensitive layer is a complementary metal oxide semiconductor (CMOS) photosensitive layer and the light source is an infrared radiation light source.

In an embodiment, standby power consumption of the touch pad is about 1 mW, and the touch pad is utilized to perform detection on the touch operation.

At Step 602, a touch position of the touch operation is obtained when the touch operation is detected. In an embodiment, the touch pad, when detecting the touch operation, obtains a touch position of the touch operation. Here, the touch position of the touch operation may be represented by two-dimensional coordinates, for example, (x, y); wherein x represents the horizontal axis, and y represents the vertical axis.

At Step 603, it may be judged whether the touch position of the touch operation is located in a first area. In an embodiment, a portion of a touch area of the touch pad is used for finger vein recognition, and the whole area of the touch pad may be used to detect the touch operation. The user, when needing to use a finger vein recognition function, touches an area for the finger vein recognition with the finger (i.e., the target), i.e., a first area. At this time, the touch pad determines the touch position according to the detected touch operation and judges that the touch operation occurs in the first area according to the touch position.

At Step 604: the recognition apparatus is set to be in an on-state when the touch position of the touch operation is located in the first area and the recognition apparatus is used to acquire and recognize an image of a target. In an embodiment, when the touch operation is detected at the first area of the touch pad, a hardware interrupt is sent to wake up the recognition apparatus, such that the recognition apparatus is in an on-state. The recognition apparatus, after receiving the interrupt, begins to acquire and recognize an image of the target. If successful recognition is made, a corresponding operation is performed, e.g., a security authentication process is performed to thereby realize secure startup and login. There is no need to turn on the recognition apparatus to perform the finger vein recognition when the technical solution of the embodiment is applied to a shutdown process, thereby ensuring that the power consumption is about 1 mW during shutdown. In addition, when secure startup and login are realized by the finger vein recognition function, the touch pad continues to detect whether a finger vein acquisition area (i.e., the first area) is covered in real time. If the area is covered, the recognition apparatus is woken up by the hardware interrupt and the finger vein recognition function is realized after the recognition apparatus is turned on.

In an embodiment, the acquired image is a finger vein image and the means further comprise a processor for resolving the image of the target to obtain feature data of the target. In an embodiment, the sensor and one light source are integrated with the touch pad, thereby ensuring the integrity of ID. One light source is designed at the first area below the touch pad and the sensor is designed at the second area below the touch pad, thereby ensuring that a finger vein image is capable of being detected when the finger is above the touch pad, realizing an integrated design and improving the look and feel.

At Step 605, the recognition apparatus is controlled to be in an off-state when the touch position of the touch operation is located outside the first area. In an embodiment, when the touch pad detects that the touch operation does not occur at the finger vein acquisition area (the first area), the recognition apparatus is turned off by the hardware interrupt to achieve the purpose of saving power. In addition, even if the touch pad does not detect any touch operations, the recognition apparatus is turned off by the hardware interrupt to achieve the purpose of saving power.

The detection method of the embodiment utilizes the touch pad to reduce the standby power consumption of the recognition apparatus, which realizes the effect that the recognition apparatus is turned off when there is no user operation. Additionally, the recognition apparatus may be turned on quickly when the user uses the finger vein recognition function. The embodiment provides a feasible solution for intelligent startup, thereby increasing endurance time of the electronic device and improving user experience.

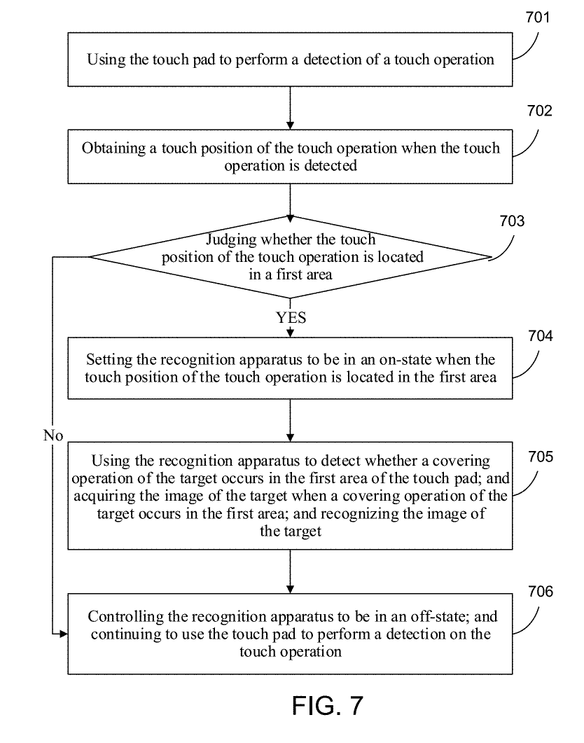

Referring now to FIG. 7, a schematic flow diagram of a detection method according to another embodiment is illustrated. A detection method in this example is applied to an electronic device which comprises a body, a touch pad disposed on the body, and a recognition apparatus located below the touch pad.

Steps 701-703 are equivalent to steps 601-603 in FIG. 6, which have been described above and are not duplicated here.

At Step 704, the recognition apparatus is set to be in an on-state when the touch position of the touch operation is located in the first area. In an embodiment, when the touch operation is detected at the first area of the touch pad, a hardware interrupt is sent to wake up the recognition apparatus, such that the recognition apparatus is in an on-state.

At Step 705: the recognition apparatus is used to detect whether a covering operation of the target occurs in the first area of the touch pad. The recognition apparatus is also used to acquire the image of the target when a covering operation of the target occurs in the first area and recognize the image of the target.

The recognition apparatus, after receiving the interrupt, begins to acquire and recognize the image of the target, and if successful recognition is made, a corresponding operation is performed, e.g., a security authentication process is performed to thereby realize secure startup and login. There is no need to turn on the recognition apparatus to perform the finger vein recognition when the embodiment is applied to a shutdown process, thereby ensuring that the power consumption is about 1 mW during shutdown. In addition, when secure startup and login are realized by the finger vein recognition function, the touch pad continues to detect whether a finger vein acquisition area (i.e., the first area) is covered in real time, and if the area is covered, the recognition apparatus is woken up by the hardware interrupt, and the finger vein recognition function is realized after the recognition apparatus is turned on.

At Step 706, the recognition apparatus is set to be in an off-state after acquiring the image of the target; controlling the recognition apparatus to be in an off-state when the touch position of the touch operation is located outside the first area; and continuing to use the touch pad to perform a detection on the touch operation, thereby achieving the purpose of saving power. The touch pad continues to be used to perform a detection of the touch operation to again turn on or off the recognition apparatus by the touch pad.

In an embodiment, when the touch pad detects that the touch operation does not occur at the finger vein acquisition area (the first area), the recognition apparatus is turned off by the hardware interrupt to achieve the purpose of saving power. In addition, even if the touch pad does not detect any touch operations, the recognition apparatus is turned off by the hardware interrupt to achieve the purpose of saving power.

The detection method of the described embodiments utilize the touch pad to reduce the standby power consumption of the recognition apparatus, which realizes the effect that the recognition apparatus is turned off when there is no user operation and that the recognition apparatus may be turned on quickly when the user uses the finger vein recognition function. The described embodiments provide a feasible solution for intelligent startup, thereby increasing endurance time of the electronic device and improving user experience.

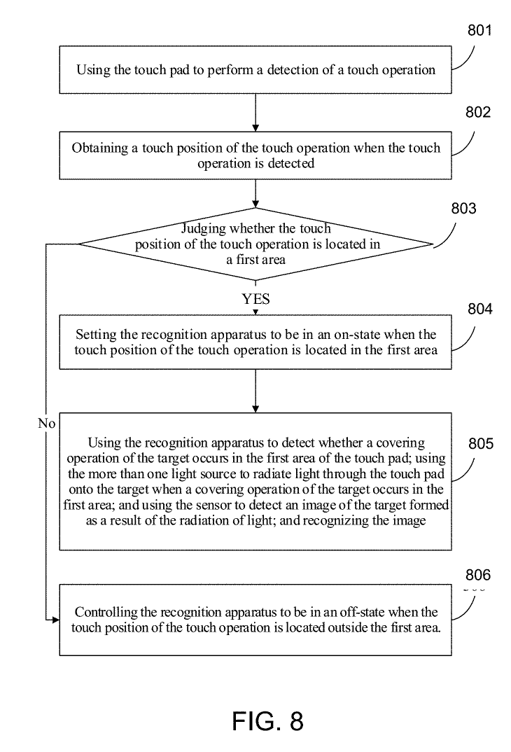

Referring now to FIG. 8, a schematic flow diagram of a detection method according to another embodiment is illustrated. A detection method in this example is applied to an electronic device which comprises a body, a touch pad disposed on the body, and a recognition apparatus located below the touch pad.

Steps 801-804 and 806 are equivalent to steps 701-704 and 605 respectively, which are described above and are not duplicated here.

At Step 805, the recognition apparatus is used to detect whether a covering operation of the target occurs in the first area of the touch pad, using the more than one light source to radiate light through the touch pad onto the target when a covering operation of the target occurs in the first area; and using the sensor to detect an image of the target formed as a result of the radiation of light; and recognizing the image.

The recognition apparatus, after receiving the interrupt, begins to acquire and recognize the image of the target, and if successful recognition is made, a corresponding operation is performed, e.g., a security authentication process is performed to thereby realize secure startup and login. There is no need to turn on the recognition apparatus to perform the finger vein recognition when the technical solution of the embodiment of the present invention is applied to a shutdown process, thereby ensuring that the power consumption is about 1 mW during shutdown. In addition, when secure startup and login are realized by the finger vein recognition function, the touch pad continues to detect whether a finger vein acquisition area (i.e., the first area) is covered in real time, and if the area is covered, the recognition apparatus is woken up by the hardware interrupt, and the finger vein recognition function is realized after the recognition apparatus is turned on.

In the embodiment, with reference to FIG. 10, the light emitted from the light source is radiated through the touch pad onto the right side of the target; the sensor is used to detect an image of the left side of the target formed as a result of the radiation of light; and finally the step of recognizing the image is performed.

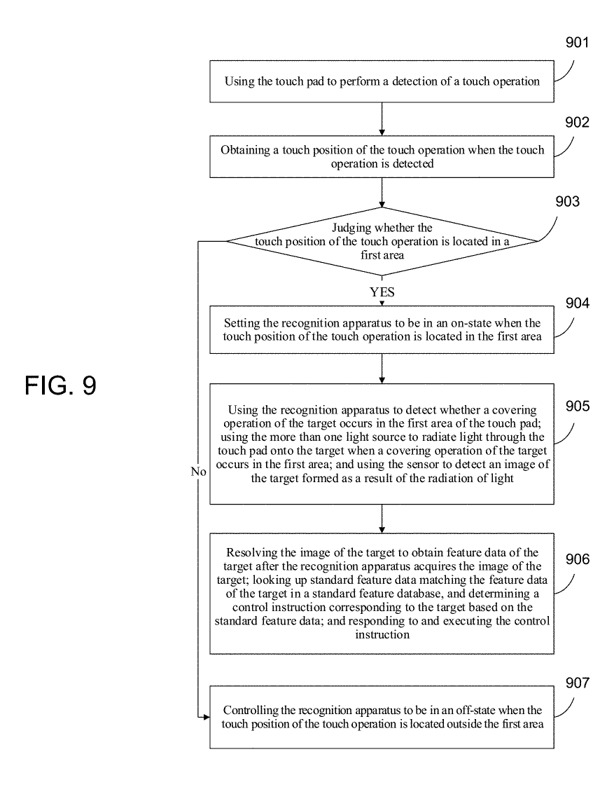

Referring now to FIG. 9, a schematic flow diagram of a detection method according to an embodiment is illustrated. A detection method in this example is applied to an electronic device which comprises a body, a touch pad disposed on the body, and a recognition apparatus located below the touch pad.

Steps 901-905 and 907 are equivalent to steps 801-806, which are described above and are not duplicated here.

At Step 906, the image of the target is resolved to obtain feature data of the target after the recognition apparatus acquires the image of the target; resolved to look up standard feature data matching the feature data of the target in a standard feature database, and resolved to determine a control instruction corresponding to the target based on the standard feature data; and resolved to respond to and execute the control instruction.

Here, the control instruction can be any set instruction, such as a startup instruction, a photographing instruction, a recording instruction and the like. In an embodiment, the standard feature database stores feature data of the fingers of different users and different users correspond to different instructions. As such, the electronic device may respond to different users accordingly according to the finger vein recognition. Furthermore, respective rights can be set for particular users, and the feature database only stores the feature data of particular users, while for other users, the electronic device does not respond to them.

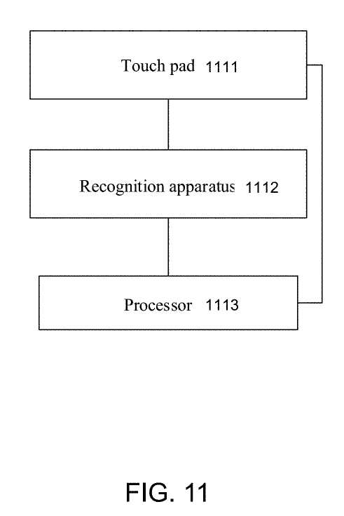

Referring now to FIG. 11, a structural schematic diagram showing an electronic device according to an embodiment is illustrated. As shown in FIG. 11, the electronic device comprises a body (not shown in the figure), a touch pad 1111 disposed on the body, a recognition apparatus 1112 located below the touch pad 1111, and a processor 1113.

The touch pad 1111 is configured for performing a detection of a touch operation and obtaining a touch position of the touch operation when detecting a touch operation. The processor 1113 is configured for judging whether the touch position of the touch operation is located in the first area; setting the recognition apparatus 1112 to be in an on-state when the touch position of the touch operation is located in the first area; and controlling the recognition apparatus 1112 to be in an off-state when the touch position of the touch operation is located outside the first area. The recognition apparatus 1112 is configured for acquiring and recognizing an image of the target when in an on-state.

The recognition apparatus 1112 is further configured for detecting whether a covering operation of the target occurs in the first area of the touch pad 1111 and acquiring the image of the target when a covering operation of the target occurs in the first area. The processor 1113 is further configured for setting the recognition apparatus 1112 to be in an off-state after acquiring the image of the target and controlling the touch pad 1111 to continue performing a detection of the touch operation.

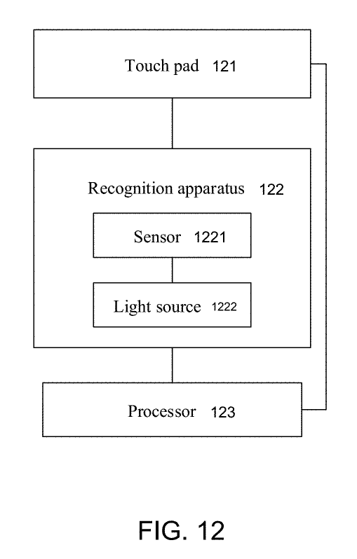

Referring now to FIG. 12, a structural schematic diagram showing an electronic device according to an embodiment is illustrated. As shown in FIG. 12, the electronic device comprises a body (not shown in the figure), a touch pad 121 disposed on the body, a recognition apparatus 122 located below the touch pad 121, and a processor 123. The touch pad 121, recognition apparatus 122, and processor 123 in FIG. 12 comprise features and configurations equivalent to the ones described in FIG. 11 which are described above and are therefore are not duplicated here.

Additionally, the recognition apparatus 122 comprises a sensor 1221 and more than one light source 1222. The recognition apparatus 122 is further configured for using the more than one light source 1222 to radiate light through the touch pad 121 onto the target when a covering operation of the target occurs in the first area and using the sensor 1221 to detect the image of the target formed as a result of the radiation of light.

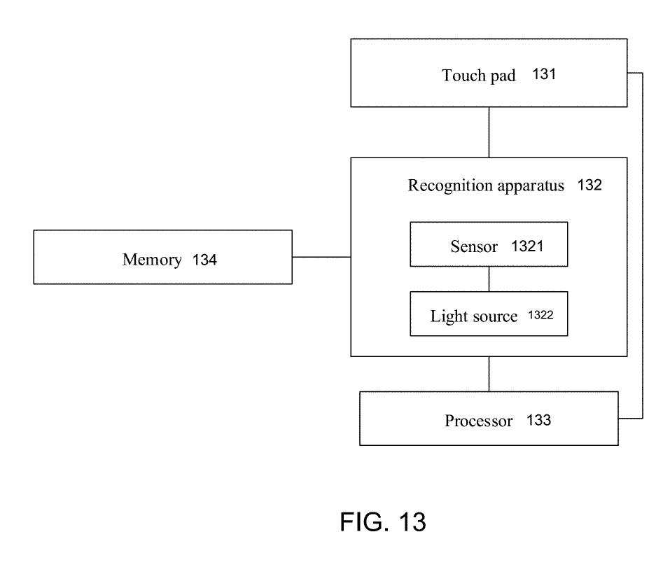

Referring now to FIG. 13, a structural schematic diagram showing an electronic device according to an embodiment is illustrated. As shown in FIG. 13, the electronic device comprises a body (not shown in the figure), a touch pad 131 disposed on the body, a recognition apparatus 132 located below the touch pad 131, and a processor 133. The touch pad 131, recognition apparatus 132, and processor 133 in FIG. 13 comprise features and configurations equivalent to the ones described in FIG. 12 which are described above and are therefore are not duplicated here.

Additionally, the processor 133 is further configured for resolving the image of the target to obtain feature data of the target after the recognition apparatus acquires the image of the target; looking up standard feature data matching the feature data of the target in a standard feature database, and determining a control instruction corresponding to the target based on the standard feature data; and responding to and executing the control instruction. The electronic device further comprises a memory 134, configured for storing the standard feature database.

### Detection Apparatus and Electronic Device

In the vein recognition technique, the infrared radiation light source irradiates infrared radiation light onto a finger, and a vein sensor acquires infrared radiation imaging on the finger and further obtains vein data. When the vein sensor and the light source are integrated in a notebook, it is difficult to choose a position for placement, and the vein sensor and the light source are commonly required to be exposed to a casing, leading to a poor look and feel.

An embodiment provides a detection apparatus, wherein the detection apparatus comprises a body, a touch pad disposed on the body, a sensor, and more than one light source located below the touch pad. In an embodiment, the detection apparatus is configured so that the more than one light source may be located on a first area below the touch pad, the sensor may be located on a second area below the touch pad, and the first area being different from the second area. When more than one light source is located on the first area below the touch pad, light emitted from more than one light source can irradiate through the touch pad onto a target. When the sensor is located on the second area below the touch pad, the sensor is capable of detecting an image of the target formed as a result of the irradiation of light.

In an embodiment, the apparatus comprises one light source. When the light source is located on the first area below the touch pad, the light emitted from the light source can irradiate onto a first side of the target through the touch pad. When the sensor is located on the second area below the touch pad, the sensor is capable of detecting an image of a second side of the target formed as a result of the irradiation of light. An area of the first side is different from an area of the second side.

In an embodiment, the apparatus comprises more than two light sources. When more than two light sources are located on the first area below the touch pad, light emitted from more than two light sources can irradiate through the touch pad onto more than two sides of the target, where the more than two sides being a first set of sides. When the sensor is located on the second area below the touch pad, the sensor is capable of detecting an image of a second side of the target formed as a result of the irradiation of light. The area of the second side is located outside the area of the first set of sides.

In an embodiment, a bottom surface of the touch pad is coated with a light-shielding layer which is capable of projecting a first wave band light and reflecting a second wave band light.

In an embodiment, the light emitted from the light source belongs to the first wave band and the light reflected from the surfaces of the light source and the sensor belongs to the second wave band.

In an embodiment, the sensor comprises a lens and a photosensitive layer. The light reflected from the target as a result of the irradiation of light can be converged on the photosensitive layer through the lens to form an image. In an embodiment, the photosensitive layer is a complementary metal oxide semiconductor (CMOS) photosensitive layer, and the light source is an infrared radiation light source.

In an embodiment, the apparatus further comprises a processor for resolving the image of the target formed as a result of the irradiation of light to obtain feature data of the target. In an embodiment, the apparatus further comprises; a memory, used for storing a standard feature database, the standard feature database comprising more than one standard feature datum; the processor, further used for querying standard feature data matching the feature data of the target in the standard feature database in the memory, and determining identity information of the target according to the standard feature data.

Referring now to FIG. 10, a structural schematic diagram of a detection apparatus is illustrated. As shown in FIG. 10, the apparatus comprises a body 11, a touch pad 12 disposed on the body 11, a sensor 13 and one light source 14 located below the touch pad 12; wherein the one light source 14 is located on a first area below the touch pad 12, the sensor 13 is located on a second area below the touch pad 12, and the first area is different from the second area.

In an embodiment, the body 11 refers to a casing carrying the touch pad 12. The shape of the body 11 can be a rectangle, or a rectangle with curved corners, and the shape of the body 11 can be designed flexibly according to user's requirements and preferences. A light material such as plastic is generally employed as the material of the body 11 to reduce weight of the detection apparatus.

In an embodiment, the touch pad 12 is disposed on the body 11 and the touch pad 12 provides a touch operation function for the user. That is, the user can realize a touch operation on the touch pad 12, wherein the touch pad 12, after acquiring the touch operation of the user, sends a generated control instruction to the processor for response by the processor. In one implementation, the operating principle of the touch pad 12 is as follows: when the user's finger approaches or touches the touch pad 12, capacitance will be changed, and an amount of change in capacitance will be detected by a control integrated circuit (IC) of the touch pad 12 to be converted into a control instruction related to a coordinate. The touch pad 12 learns a finger movement condition by means of capacitive sensing, and when the finger touches the pad surface, an electrostatic field above the pad surface will be changed. In addition, the touch pad 12 may further have other types of operating principles, and the realized functions are the functions for providing the touch operation for the user.

In an embodiment, the sensor 13 and one light source 14 are integratedly designed below the touch pad 12 and the sensor 13 and the light source 14 are capable of realizing acquisition of a finger vein image. The one light source 14 is on the second area below the touch pad 12, and with reference to FIG. 10, specifically, the light source 14 is at a second position of the second area below the touch pad 12. The function of the light source 14 is to emit and irradiate the light through the touch pad 12 onto the target (the target here refers to an object having vital signs, such as blood flowing fingers). When the light is irradiated through the touch pad 12 onto the target, flowing blood in the target has different biological manifestations as a result of the irradiation.

In an embodiment, the sensor 13 is on the first area below the touch pad 12, and with reference to FIG. 10, specifically, the sensor 13 is at a first position of the first area below the touch pad 12 and the function of the sensor 13 is to acquire the finger vein image. In particular, the flowing blood in the target has different biological manifestations as a result of the irradiation, and based on this, the sensor 13 detects the image of the target formed as a result of the irradiation of light. Herein, the target particularly refers to the finger, such that the detected image is the finger vein image.

In an embodiment, when the light source 14 is located on the first area below the touch pad 12, light emitted from the light source 14 can irradiate through the touch pad 12 onto the first side of the target. When the sensor 13 is located on the second area below the touch pad 12, the sensor 13 is capable of detecting an image of the second side of the target formed as a result of the irradiation of light. The area of the first side is different from the area of the second side. The light emitted from the light source 14 can irradiate through the touch pad 12 onto a right side of the target and the sensor 13 is capable of detecting the image of a right side of the target formed as a result of the irradiation of light.

In an embodiment, the position of the target is referred to as a finger detect position and an area on the touch pad 12 in which the image of the target can be detected is referred to as a finger vein area.

In an embodiment, the touch pad 12 employs a design of the sensor 13 on glass (the sensor 13 here refers to the sensor 13 for realizing the function of the touch pad 12). A bottom surface of the touch pad 12 is coated with a light-shielding layer which is capable of projecting a first wave band light and reflecting a second wave band light. In the embodiment of the present invention, the light emitted from the light source 14 belongs to the first wave band and the light reflected from surfaces of the light source 14 and the sensor 13 belongs to the second wave band. In particular, a bottom surface of glass is coated with black ink as a light-shielding layer. The black ink is only transparent to infrared radiation (IR) light and reflects other wave band light, thereby ensuring that the sensor 13 and the light source 14 component inside the touch pad 12 would be hidden from view and that the appearance is aesthetic. Herein, the black ink is capable of projecting light at 850 nm, and light transmittance is 90%.

In an embodiment, the sensor 13 comprises a lens and a photosensitive layer. The light reflected from the target as a result of the irradiation of light can be converged on the photosensitive layer through the lens to form an image. Herein, the focus of the lens is adjusted to a suitable range according to the position of the sensor 13 and the light reflected from the target as a result of the irradiation of light can be converged on the photosensitive layer through the lens to form an image. In one implementation, the photosensitive layer is a CMOS photosensitive layer, and the light source 14 is an infrared radiation light source 14.

In an embodiment, the acquired image is a finger vein image and the apparatus further comprises a processor for resolving the image of the target formed as a result of the irradiation of light to obtain feature data of the target. The apparatus further comprises a memory used for storing a standard feature database, the standard feature database comprising more than one standard feature datum; the processor, further used for querying standard feature data matching the feature data of the target in the standard feature database in the memory, and determining identity information of the target according to the standard feature data.

In an embodiment, the sensor and one light source are integrated together with the touch pad, thereby ensuring the integrity of ID. One light source is designed on the first area below the touch pad, and the sensor is designed on the second area below the touch pad, thereby ensuring that a finger vein image can be detected when the finger is above the touch pad, realizing an integrated design, and improving the look and feel.

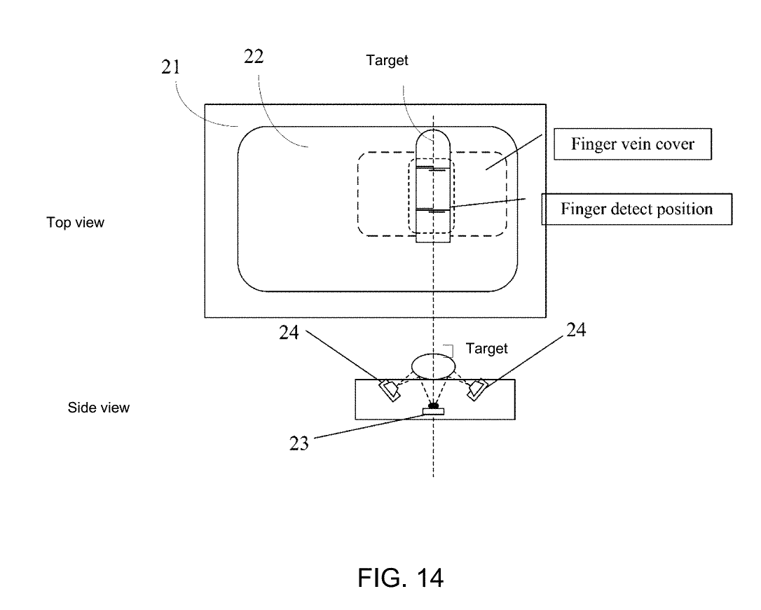

Referring now to FIG. 14, a structural schematic diagram of a detection apparatus is illustrated. As shown in FIG. 14, the apparatus comprises a body 21, a touch pad 22 disposed on the body 21, a sensor 23 and two light sources 24 located below the touch pad 22. The two light sources 24 are located on a first area below the touch pad 22, the sensor 23 is located on a second area below the touch pad 22, and the first area is different from the second area.

In an embodiment, the body 21 refers to a casing carrying the touch pad 22, the shape of the body 21 can be a rectangle, or a rectangle with curved corners, and the shape of the body 21 can be designed flexibly according to user's requirements and preferences. A light material such as plastic is generally employed as the material of the body 21 to reduce weight of the detection apparatus.

In an embodiment, the touch pad 22 is disposed on the body 21 and the touch pad 22 provides a touch operation function for the user. That is, the user can realize a touch operation on the touch pad 22, wherein the touch pad 22, after acquiring the touch operation of the user, sends a generated control instruction to the processor for response by the processor. In one implementation, the operating principle of the touch pad 22 is as follows: when the user's finger approaches or touches the touch pad 22, capacitance will be changed, and an amount of change in capacitance will be detected by a control integrated circuit (IC) of the touch pad 22 to be converted into a control instruction related to a coordinate. The touch pad 22 learns a finger movement condition by means of capacitive sensing and when the finger touches the pad surface, an electrostatic field above the pad surface will be changed. In addition, the touch pad 22 may further have other types of operating principles, and the realized functions are the functions for providing the touch operation for the user.

In an embodiment, the sensor 23 and two light sources 24 are integratedly designed below the touch pad 22, and the sensor 23 and the light sources 24 are capable of realizing acquisition of the finger vein image. The two light sources 24 are on the second area below the touch pad 22, and with reference to FIG. 14, specifically, the two light sources 24 are at a second position and a third position of the second area below the touch pad 22, respectively. The function of the light sources 24 is to emit and irradiate light through the touch pad 22 onto the target (the target here refers to an object having vital signs, such as blood flowing fingers). When the light is irradiated through the touch pad 22 onto the target, flowing blood in the target has different biological manifestations as a result of the irradiation.

In an embodiment, the sensor 23 is on the first area below the touch pad 22. The sensor 23 is at a first position of the first area below the touch pad 22 and the function of the sensor 23 is to acquire the finger vein image. In particular, the flowing blood in the target has different biological manifestations as a result of the irradiation and based on this, the sensor 23 detects the image of the target formed as a result of the irradiation of light. Herein, the target particularly refers to the finger, such that the detected image is the finger vein image.

In an embodiment, when more than two light sources 24 are located on the first area below the touch pad 22, light emitted from the more than two light sources 24 can irradiate through the touch pad 22 onto more than two sides of the target, more than two sides being a first set of sides. When the sensor 23 is located on the second area below the touch pad 22, the sensor 23 is capable of detecting an image of the second side of the target formed as a result of the irradiation of light. The area of the second side is located outside the area of the first set of sides. The light emitted from two light sources 24 can irradiate through the touch pad 22 onto both left and right sides of the target, and the sensor 23 is capable of detecting the image of a bottom surface of the target formed as a result of the irradiation of light.

In an embodiment, the position of the target is referred to as a finger detect position and an area on the touch pad 22 in which the image of the target can be detected is referred to as a finger vein area.

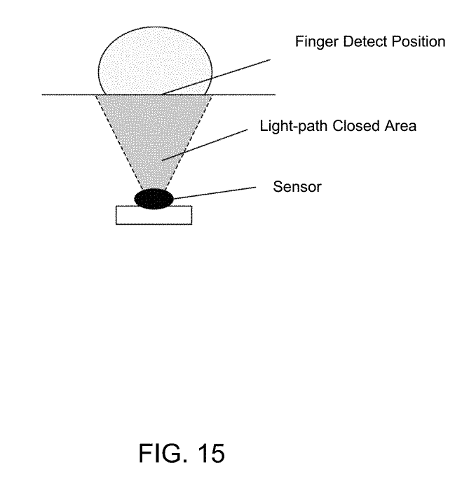

Referring now to FIG. 15, a structural schematic diagram of light path detection is illustrated according to an embodiment. With reference to FIG. 15, the sensor is disposed right below the finger detect position, moreover, a detection area of the sensor is utilized as a closed area. As such, the detection of the sensor is not influenced by the light source and the sensor only obtains the image of the finger detect position.

In an embodiment, the touch pad 22 employs a design of the sensor 23 on glass (the sensor 23 here refers to the sensor 23 for realizing the function of the touch pad 22). A bottom surface of the touch pad 22 is coated with a light-shielding layer which is capable of projecting a first wave band light and reflecting a second wave band light. In an embodiment, the light emitted from the light source 24 belongs to the first wave band. The light reflected from surfaces of the light source 24 and the sensor 23 belong to the second wave band. In particular, a bottom surface of glass is coated with black ink as a light-shielding layer. The black ink is only transparent to infrared radiation (IR) light and reflects other wave band light, thereby ensuring that the sensor 23 and the light source 24 component inside the touch pad 22 would be hidden from view and that the appearance is aesthetic. Herein, the black ink is capable of projecting light at 850 nm, and light transmittance is 90%.

In an embodiment, the sensor 23 comprises a lens and a photosensitive layer. The light reflected from the target as a result of the irradiation of light can be converged on the photosensitive layer through the lens to form an image. Herein, the focus of the lens is adjusted to a suitable range according to the position of the sensor 23. The light reflected from the target as a result of the irradiation of light can be converged on the photosensitive layer through the lens to form an image. In one implementation, the photosensitive layer is a CMOS photosensitive layer, and the light source 24 is an infrared radiation light source 24.

In an embodiment, the acquired image is a finger vein image and the apparatus further comprises a processor for resolving the image of the target formed as a result of the irradiation of light to obtain feature data of the target. The apparatus further comprises a memory used for storing a standard feature database, the standard feature database comprising more than one standard feature datum, the processor, further used for querying standard feature data matching the feature data of the target in the standard feature database in the memory, and determining identity information of the target according to the standard feature data.

In an embodiment, the sensor and two light sources are integrated together with the touch pad, thereby ensuring the integrity of ID. Two light sources are designed on the first area below the touch pad, and the sensor is designed on the second area below the touch pad, thereby ensuring that a finger vein image can be detected when the finger is above the touch pad, realizing an integrated design, and improving the look and feel.

It should be understood by a person skilled in the art that the number of the light sources in the present embodiment can be adjusted according to actual situations, as long as it is ensured that the area irradiated by the light source on the target is different from the area detected by the sensor.

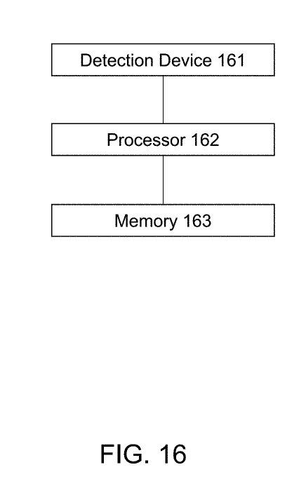

In addition, an embodiment further provides an electronic device, and as shown with reference to FIG. 16, the electronic device comprises a detection apparatus 161, a processor 162, and a memory 163. The detection apparatus 161 comprises a body, a touch pad disposed on the body, a sensor and more than one light source located below the touch pad. The more than one light source is located on a first area below the touch pad, the sensor being located on a second area below the touch pad, and the first area being different from the second area. When more than one light source is located on the first area below the touch pad, light emitted from the more than one light source can irradiate through the touch pad onto a target. When the sensor is located on the second area below the touch pad, the sensor is capable of detecting an image of the target formed as a result of the irradiation of light.

The processor 162 is used for resolving the image of the target formed as a result of the irradiation of light to obtain feature data of the target. The memory 163 is used for storing a standard feature database, the standard feature database comprising more than one standard feature datum. The processor 162 is further used for querying standard feature data matching the feature data of the target in the standard feature database in the memory, and determining identity information of the target according to the standard feature data.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A detection method, comprising:
detecting, using a touch pad of an electronic device, a touch operation;
determining whether a touch position of the touch operation is located in a first area of the electronic device;
obtaining, using an recognition apparatus of the electronic device, an image of a target associated with the touch operation responsive to determining that the touch operation is located in the first area of the electronic device.

2. The detection method of claim 1, wherein the obtaining of the image of the target is responsive to a covering operation of the target being detected in the first area of the electronic device.

3. The detection method of claim 2, further comprising disabling the recognition apparatus responsive to recognizing the image of the target.

4. The detection method of claim 2, responsive to detecting the covering operation, further comprising:
radiating, using at least two light sources, light through the touch pad onto the target and using a sensor to detect the image of the target formed from the radiation.

5. The detection method of claim 1, further comprising recognizing the image of the target, wherein the recognizing comprises:
resolving the image of the target to obtain feature data of the target;
determining, using a standard feature database, that the feature data of the target matches standard feature data contained in the standard feature database;
determining a control instruction corresponding to the target based on the standard feature data; and
executing the control instruction.

6. An electronic device, comprising:
a fingerprint recognition unit comprising an acquisition module and a processing module; and
wherein the acquisition module and the processing module are arranged at different sides of the electronic device, and the acquisition module and the processing module are operatively coupled by a first connection module.

7. The electronic device of claim 6, further comprising:
a display unit;
wherein the acquisition module is operatively coupled to the display unit at a side of the display unit having a display surface; and
the processing module is operatively coupled to the display unit at a side of the display unit not having the display surface.

8. The electronic device of claim 7, wherein the display surface of the display unit comprises a display area and a non-display area, wherein the acquisition module is located in the non-display area.

9. The electronic device of claim 7, further comprising an interaction unit located on an external surface of the display unit, wherein the interaction unit comprises an interaction shielding area.

10. The electronic device of claim 6, wherein the fingerprint recognition unit further comprises a protection module located on an external surface of the acquisition module.

11. The electronic device of claim 10, wherein the protection module and the acquisition module are fixedly connected by an adhesive.

12. The electronic device of claim 11, wherein the adhesive is a transparent adhesive.

13. The electronic device of claim 6, further comprising:
a main control unit and a display unit, wherein the display unit comprises a display screen operatively coupled to a display signal connection module;
the processing module being operatively coupled to the display signal module by a second connection module;
the display signal module being operatively coupled to the main control unit by a third connection module.

14. The electronic device of claim 6, wherein the first connection module comprises a flexible connection circuit board.

15. A detection apparatus, comprising:
a processor;
a body;
a touch pad disposed on the body;
at least one light source located on a first area below the touch pad, wherein the first area is composed of a translucent material; and
a sensor located on a second area below the touch pad.

16. The detection apparatus of claim 15, wherein a bottom surface of the touch pad is coated with a light-shielding layer capable of projecting a first wave band light and reflecting a second wave band light.

17. The detection apparatus of claim 15, wherein the at least one light source comprises a plurality of light sources.

18. The detection apparatus of claim 15, wherein the sensor comprises a lens and a photosensitive layer, wherein the lens and the photosensitive layer are capable of converging the reflected light on the photosensitive layer through the lens to form an image.

19. The detection apparatus of claim 18, wherein the photosensitive layer is a complementary metal oxide semiconductor (CMOS) photosensitive layer and the at least one light source is an infrared radiation light source.

20. The detection apparatus of claim 15, further comprising a memory for storing a standard feature database.
